(19) United States
(12) Patent Application Publication
(10) Pub. No.: US 2018/0111405 A1
(43) Pub. Date: Apr. 26, 2018

(54) MICRO-OPTICAL DEVICE DOUBLE-SIDED IMAGING, PREPARATION METHOD THEREFOR AND APPLICATION THEREOF

(71) Applicant: Shanghai Techsun Packing Materials Co., Ltd., Shanghai (CN)

(72) Inventors: Liangheng Xu, Shanghai (CN); Xiaolei Zhuang, Shanghai (CN); Lanxin Dong, Shanghai (CN); Renshun You, Shanghai (CN)

(21) Appl. No.: 15/565,859

(22) PCT Filed: Dec. 9, 2015
(86) PCT No.: PCT/CN2015/096764

§ 371 Date: Oct. 11, 2017

(30) Foreign Application Priority Data
Apr. 16, 2015 (CN) CN 201510181774.3

(51) Int. Cl. B42D 25/342; G02B 3/00; G02B 27/22

(52) U.S. Cl. CPC B42D 25/342; G02B 2003/0093; G02B 27/22; G02B 3/0037

(57) ABSTRACT

A micro-optical device for double-sided imaging, a preparation method therefor and an application thereof. The micro-optical device for double-sided imaging comprises a first microlens layer (1), a functional layer (4), a second microlens layer (2) and a miniature graphic layer (3) which are mutually compounded in sequence, the first microlens layer (1) being a first microlens array formed by arranging a plurality of first microlenses (11), and the second microlens layer (2) being a second microlens array formed by arranging a plurality of second microlenses (21); and the functional layer (4) is arranged on the surface of the second microlens layer (2), and a material for the functional layer (4) has a refractive index different from that of a surrounding material. The micro-optical device can image on two faces; and after products prepared by adopting the device are used for packaging and anti-counterfeiting of bills, stereoscopic images can be represented on front sides and back sides, and representation forms of the two stereoscopic images are different, thereby greatly enhancing attraction and anti-copying capability of the products.

### TECHNICAL FIELD

The present invention relates to a micro-optical device.

### BACKGROUND

The Moire amplification technology based on microlens and micrographic arrays has been widely concerned in anti-counterfeiting field. Drinkwater et al., put forward the use of a security device that combines a microlens array having a pore size of 50-250 μm and a micrographic array in U.S. Pat. No. 5,712,731.

In U.S. Patent No. 2005/0180020A1, R. A. Steenblik et al., expand the scope of the security device based on the microlens array, i.e. reducing the pore size of the microlens to be less than 50 μm, by means of more precise processing techniques and more transformations.

The foresaid micro-optical device using the microlens structure is for unidirectional imaging, and one can only see the stereoscopic sloshing image from one side, so it has limitations no matter whether being used for packaging materials or for anti-counterfeiting of bills.

### SUMMARY OF THE INVENTION

The object of the present invention is to disclose a micro-optical device for double-sided imaging, a preparation method therefor and an application thereof, in order to overcome the defects existing in the prior art.

The micro-optical device for double-sided imaging comprises a first microlens layer, a functional layer, a second microlens layer and a miniature graphic layer which are mutually compounded in sequence;

the first microlens layer is a first microlens array formed by arranging a plurality of first microlenses;

the second microlens layer is a second microlens array formed by arranging a plurality of second microlenses;

the functional layer is arranged on the surface of the second microlens layer, and a material for the functional layer has a refractive index different from that of a surrounding material.

The beneficial effect of the present invention is that the produced micro-optical device can image on two faces; after the products prepared by adopting the device are used for packaging and anti-counterfeiting of bills, stereoscopic images can be represented on front sides and back sides; and the representation forms of the two stereoscopic images are different, thereby greatly enhancing attraction and anti-copying capability of the products.

### DESCRIPTION OF THE DRAWINGS

FIG. 1 is a structural schematic diagram of a micro-optical device for double-sided imaging.

FIG. 2 is a schematic diagram of the transmission focusing of a first microlens and a schematic diagram of the reflection focusing of a second microlens.

FIG. 3 is a structural schematic diagram of a functional layer.

FIG. 4 is a schematic diagram of the first microlens, the second microlens, and the miniature graphic in a periodic arrangement.

FIG. 5 is a schematic diagram of the inclined angle between the symmetrical axes of two layers in the periodic arrangement.

FIG. 6 is a schematic diagram of the first microlens, the second microlens, and the miniature graphic in a random arrangement.

FIG. 7 is a schematic diagram of the preparation of the miniature graphic.

FIG. 8 is a schematic diagram of a miniature graphic as a micro-structure.

FIG. 9 is a schematic diagram of a bill having double-sided window security lines that utilizes the micro-optical device of the present invention.

FIG. 10 is a sectional schematic diagram of a bill.

FIG. 11 is a structural schematic diagram of an invisible ciphertext.

FIG. 12 is a structural schematic diagram of a micro-optical device for double-sided imaging combined with holography.

FIG. 13 is a structural schematic diagram of another micro-optical device for double-sided imaging combined with holography.

### DETAILED DESCRIPTION OF THE EMBODIMENTS

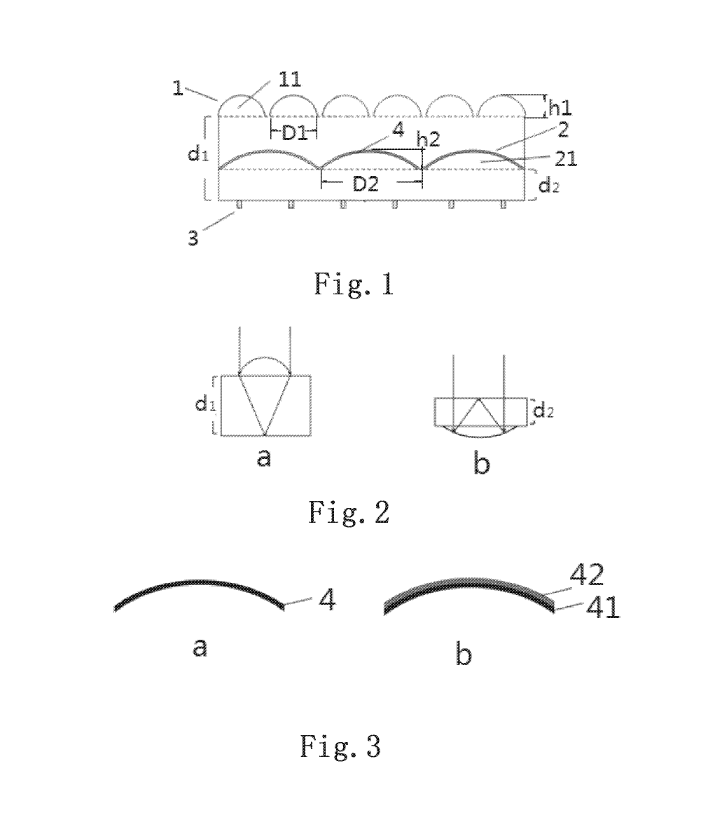

Referring to FIG. 1, the micro-optical device for double-sided imaging comprises a first microlens layer 1, a functional layer 4, a second microlens layer 2 and a miniature graphic layer 3 which are mutually compounded in sequence;

the first microlens layer 1 is a first microlens array formed by arranging a plurality of first microlenses 11;

the second microlens layer 2 is a second microlens array formed by arranging a plurality of second microlenses 21;

the functional layer is arranged on the surface of the second microlens layer, and a material for the functional layer has a refractive index different from that of a surrounding material.

Preferably, the first microlens layer 1 is a first microlens array formed by arranging the first microlens 11 in a periodic arrangement or a random arrangement, and the second microlens layer 2 is a second microlens array formed by arranging the plurality of second microlens 21 in a periodic arrangement or a random arrangement.

The substrate of the first microlens layer 1 has a refractive index of 1.4˜1.8.

The substrate of the first microlens layer 1 is selected from hot-compressible materials such as polyvinyl acetate, cellulose triacetate, polymethyl methacrylate, polystyrene, a mixture of alkyd resin and toluene diisocyanate, polyurethane, polypropylene, polyethylene-1,4-cyclohexane dimethylene terephthalate, and may be also selected from UV-curable materials such as epoxy acrylates, fatty acid-modified epoxy acrylates, and a mixture of styrene and epoxy acrylates.

The substrate of the second microlens layer 2 has a refractive index of 1.4˜1.8.

The substrate of the second microlens layer 2 is selected from hot-compressible materials such as polyvinyl acetate, cellulose triacetate, polymethyl methacrylate, polystyrene, a mixture of alkyd resin and toluene diisocyanate, polyurethane, polypropylene, polyethylene-1,4-cyclohexane dimethylene terephthalate, and may be also selected from UV-curable materials such as epoxy acrylates, fatty acid-modified epoxy acrylates, and a mixture of styrene and epoxy acrylates.

The first microlens 11 or the second microlens 21 is a spherical lens or an aspherical lens.

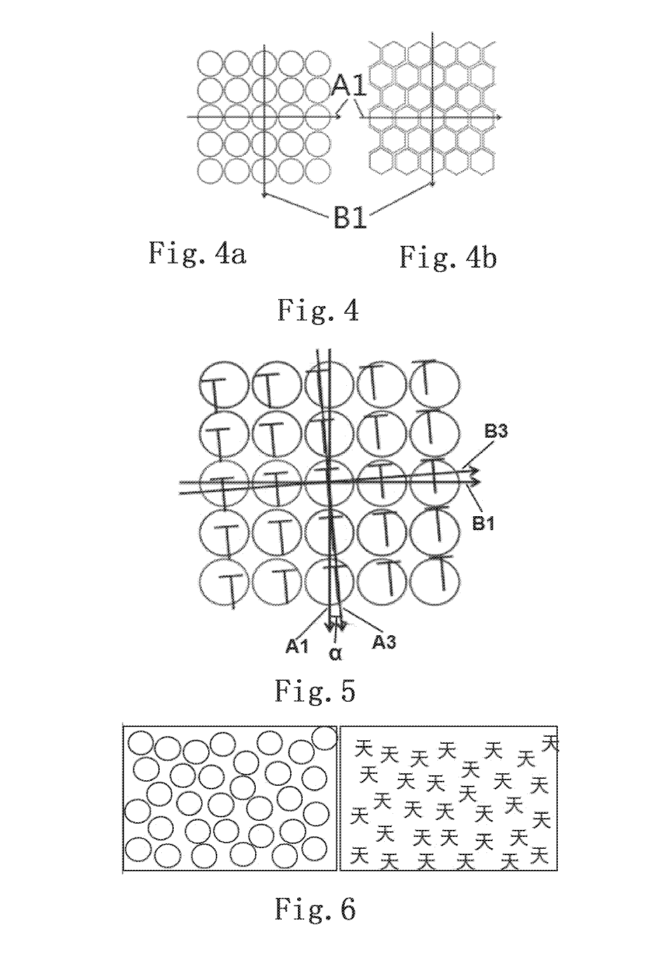

The geometry of the base of the first microlens or the second microlens is one of circle, triangular, rectangular or regular hexagon, or a combination thereof. Regular hexagon is preferable, because the microlens having a regular hexagonal base has the highest filling rate under the same lens pore size and the same lens spacing; the higher the filling rate of the microlens, the clearer and brighter the obtained macroscopically magnified graphic information. Referring to FIG. 4, FIG. 4a illustrates a schematic diagram of the circular base microlens of the first microlens 11 and the second microlens 21 in a rectangular arrangement, and FIG. 4b illustrates a schematic diagram of the regular hexagonal base microlens of the first microlens 11 and the second microlens 21 in a honeycomb arrangement.

The filling rate refers to the ratio of the area occupied by the microlens to the total area. The ratio of the total area of the first microlens 11 to the total area of the first microlens layer 1 is in a range of from 40% to 90%, and the ratio of the total area of the second microlens 21 to the total area of the second microlens layer 2 is in a range of from 40% to 90%.

The material for the functional layer has a great transmittance to visible light and has a refractive index different from that of the surrounding material, which corresponds to a layer of refractive index difference array with a micro-arc shaped structure formed within the material. The functional layer 4 has a thickness of 10˜1000 nm, preferably 10˜100 nm.

Preferably, as shown in FIG. 3, the layer number of the functional layer 4 is 1 or more, preferably 1 to 3; the multilayered functional layer has a stronger ability to fully reflect light than the monolayer film structure.

FIG. 3a illustrates the monolayer film structure of the functional layer. The material for the functional layer 4 has a refractive index greater than that of the surrounding material. This structure can only create a full reflection between the functional layer 4 and the surrounding material.

FIG. 3b illustrates the double-layer film structure of the functional layer. The first functional film layer 41 is compounded on the surface of the second microlens layer 1, and the second functional film layer 42 is compounded on the surface of the first functional film layer 41.

The refractive index of the first functional film layer 41 is greater than that of the second functional film layer 42. The difference between the refractive index of the first functional film layer 41 and the refractive index of the second functional film layer 42 is preferably 0.3˜0.8. The second functional film layer 42 has a refractive index greater than that of the surrounding material. Such a structure may create two full reflections between the first functional film layer 41 and the second functional film layer 42 and between the second functional film layer 42 and the surrounding material, and thereby has a stronger ability to fully reflect light than the monolayer film structure. In theory, the more the layer number of said film, the stronger its ability to fully reflect light.

The micro-optical device has a high transmittance to the light incident from the first microlens layer, but for the light incident from the miniature graphic layer, only a part of the light can pass through and a part of the light will be reflected back by the effect of full reflection, due to the presence of the arc-shaped refractive index difference.

The material for the functional layer 4 preferably has a refractive index of 1.6-3.5. The difference between the refractive index of the material for the functional layer 4 and the refractive index of the surrounding material is 0.3˜2.0, preferably 0.5˜1.5. The functional layer 4 is located on the surface of the second microlens and has a filling rate same as that of the second microlens layer.

The material for the functional layer 4 is selected from the group consisting of an oxide, a nitride, a carbide, an inorganic metal salt, a metal or a metal alloy.

The oxide is selected from the group consisting of silicon monoxide SiO, silica SiO₂, titania TiO₂, zirconium dioxide ZrO₂, hafnium oxide HfO₂, titanium monoxide TiO, trititanium pentoxide Ti₃O₅, niobium pentoxide Nb₂O₅, tantalum pentoxide Ta₂O₅, yttrium oxide Y₂O₃ or zinc oxide ZnO.

The nitride is selected from the group consisting of titanium nitride TiN, silicon nitride Si₃N₄ or boron nitride BN.

The carbide is selected from the group consisting of silicon carbide SiC or boron carbide B₄C.

The inorganic metal salt is selected from the group consisting of neodymium fluoride NdF₃, barium fluoride BaF₂, cerium fluoride CeF₃, magnesium fluoride MgF₂, lanthanum fluoride LaF₃, yttrium fluoride YF₃, ytterbium fluoride YbF₃, erbium fluoride ErF₃, zinc selenide ZnSe, zinc sulfide ZnS, lanthanum titanate LaTiO₃, barium titanate BaTiO₃, strontium titanate SrTiO₃, praseodymium titanate PrTiO₃ or cadmium sulfide CdS.

The metal is selected from the group consisting of Al, Cu, Ti, Si, Au, Ag, In, Mg, Zn, Pt, Ge and Ni.

The metal alloy is selected from the group consisting of gold germanium alloy AuGe, gold nickel alloy AuNi, nickel chromium alloy NiCr, titanium aluminum alloy TiAl, copper indium gallium alloy CuInGa, copper indium gallium selenium alloy CuInGaSe, zinc aluminum alloy ZnAl or aluminum silicon alloy AlSi.

The miniature graphic layer 3 is a miniature graphic array arranged in a periodic arrangement or a random arrangement. The material for the miniature graphic layer 3 is selected from hot-compressible materials such as polyvinyl acetate, cellulose triacetate, polymethyl methacrylate, polystyrene, a mixture of alkyd resin and toluene diisocyanate, polyurethane, polypropylene, polyethylene-1,4-cyclohexane dimethylene terephthalate, and may be also selected from UV-curable materials such as epoxy acrylates, fatty acid-modified epoxy acrylates, and a mixture of styrene and epoxy acrylates, having a thickness of 0.5˜5 microns.

The miniature graphic is a pattern or a character of micron magnitude in size. The miniature graphic has one or more of transparency, color, reflection, interference, dispersion or polarization characteristics, as long as the graphic part and the other parts can produce a contrast. Since the miniature graphic has a small size and the general printing equipment cannot print such a fine graphic structure, the method of printing a miniature graphic as disclosed in the applicant's Chinese patent No. 201110074244.0 may be used for the preparation.

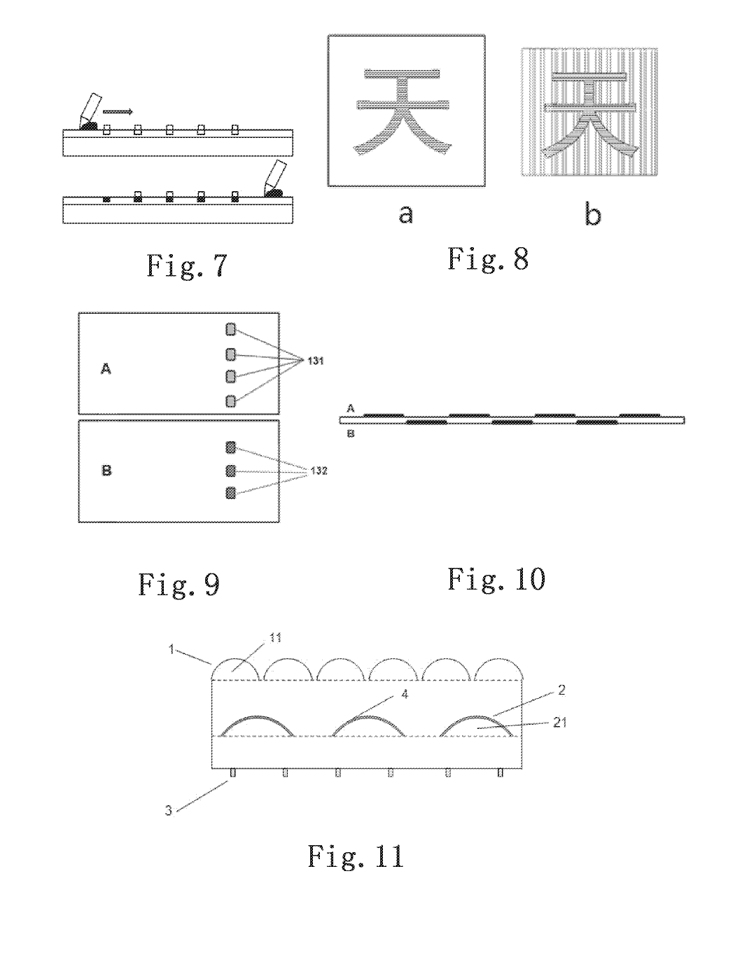

Referring to FIG. 7 and FIG. 8, FIG. 7 is a schematic diagram of making the miniature graphic by scraping ink. FIG. 8a is a representation of the miniature graphic “ [symbol] ” that is embodied by forming a contrast between the grating structure in the strokes of the miniature graphic “ [symbol] ” and the surrounding, because the grating has different optical characteristics. FIG. 8b is a representation of the miniature graphic “ [symbol] ” that is formed by creating a contrast between the grating structure in the strokes of the miniature graphic “ [symbol] ” and the grating structures of another orientation in the other parts, because the grating structures of different orientations will produce a contrast.

The miniature graphic layer 3 is located near the transmission focal plane of the first microlens layer 1 and also near the reflection focal plane of the second microlens layer 2.

Referring to FIG. 2, FIG. 2a is a schematic diagram of the transmission focusing of the first microlens 11. The distance d₁ between the first microlens layer 1 and the miniature graphic layer 3 and the structural parameters of the first microlens 11 satisfy the following relationship:

$${d}_{1} = \frac{{D}_{1}^{2} + 4 {h}_{1}^{2}}{8 {h}_{1} ( {n}_{1} - 1 )} \qquad ( 1 )$$

wherein:

D₁ is a pore size of the first microlens 11, and preferably the pore size D₁ of the first microlens 11 is 20˜500 μm;

h₁ is a spherical cap height of the first microlens 11, and preferably the spherical cap height of the first microlens 11 is 6˜100 μm;

n₁ is a refractive index of the material for the first microlens 11, and preferably the refractive index of the material for the first microlens 11 is 1.4˜1.8;

an arc-shaped functional layer 4 having a high refractive index is located between the first microlens layer 1 and the miniature graphic layer 3, which has certain impact on the propagation of light. However, the functional layer 4 has a thickness of only tens of nanometers, so the impact on the light propagation is negligible and can be ignored.

FIG. 2b is a schematic diagram of the reflection focusing of the second microlens 21.

The distance d₂ between the second microlens layer 2 and the miniature graphic layer 3 and the structural parameters of the second microlens 21 satisfy the following relationship:

$${d}_{2} = \frac{{D}_{2}^{2} - 12 {h}_{2}^{2}}{16 {h}_{2}} \qquad ( 2 )$$

wherein:

D₂ is a pore size of the second microlens 21, and preferably the pore size of the second microlens 21 is 20˜1000 μm;

h₂ is a spherical cap height of the second microlens 21, and preferably the spherical cap height of the second microlens 21 is 2˜100 μm.

In the above structure, when an observer observes from the side of the first microlens layer, the functional layer 4 is transparent for the imaging of the first microlens (the effect is little and can be ignored). The first microlens layer and the miniature graphic layer satisfy the Moire amplification condition and produce a first visual effect which, for example, is stereoscopic and sloshing. When the observer observes from the side of the miniature graphic layer, the functional layer 4 is likewise transparent for both the first microlens layer and the miniature graphic layer. However, under such a circumstance, the locations of the miniature graphic layer and the first microlens layer 1 are inverted, which do not satisfy the Moire amplification condition and will not generate obvious visual effect. But, because of the presence of the micro-arc shaped refractive index difference array, the light incident from the miniature graphic layer will be partly reflected back fully, which corresponds to that the miniature graphic layer 3 is reflected for imaging by the second microlens layer 2. Then, the miniature graphic layer and the second microlens layer satisfy the Moire amplification condition and produce a second visual effect which, for example, is stereoscopic and sloshing. The brightness of the second visual effect is affected by the ambient light intensity and the refractive index difference of the functional layer. The stronger the ambient light intensity, the more the light of full reflection, and the more obvious the second visual effect. The greater the refractive index difference of the functional layer, the stronger its ability to fully reflect the light, and the more obvious the second visual effect.

Referring to FIG. 4, when the first microlens array, the second microlens array and the miniature graphic array are in a periodic arrangement, the first microlenses of the first microlens layer 1, the second microlenses of the second microlens layer 2 and the miniature graphics of the miniature graphic layer 3 are all in a periodic arrangement. There are two mutually perpendicular symmetrical axes A1 and B1 in the plane. A1 is the symmetry axis of the array in the X-axis direction, while B1 is the symmetry axis of the array in the Y-axis direction. For the three-layer structure, each layer is symmetrical in the X and Y axes. The respective units in each layer have a fixed arrangement period along the direction of the symmetrical axes. The parameters of the first microlens layer 1 and the miniature graphic layer 3 satisfy the following relationship:

$${m}_{1} = \frac{{N}_{1} {T}_{1}}{\sqrt{{( {T}_{3} cos {α}_{1} - {N}_{1} {T}_{1} )}^{2} + {( {T}_{3} sin {α}_{1} )}^{2}}} \qquad ( 3 )$$

wherein:

m₁ a the macroscopic magnification of the first visual effect, T₁ is the arrangement period of the first microlens array layer, T₃ is the arrangement period of the miniature graphic array, α₁ is an inclined angle between the symmetrical axis of the first microlens array and the symmetrical axis of the miniature graphic array. As shown in FIGS. 5, A1 and B1 are symmetrical axes of the first microlens array, A3 and B3 are symmetrical axes of the miniature graphic array in FIG. 5;

N₁ is a coefficient, N₁=0.1˜10;

T₁=20˜500 μm, T₃=20˜500 μm, α₁=0˜5°;

the term “macroscopic magnification of the first visual effect” refers to a ratio of the size of the macroscopic miniature graphic seen from the side of the first microlens layer by eyes to the actual size of the miniature graphic;

the parameters of the second microlens layer 2 and the miniature graphic layer 3 satisfy the following relationship:

$${m}_{2} = \frac{{N}_{2} {T}_{2}}{\sqrt{{( {T}_{3} cos {α}_{2} - {N}_{2} {T}_{2} )}^{2} + {( {T}_{3} sin {α}_{2} )}^{2}}} \qquad ( 4 )$$

wherein:

m₂ a the macroscopic magnification of the second visual effect, T₂ is the arrangement period of the second microlens array, T₃ is the arrangement period of the miniature graphic array, α₂ is an inclined angle between the symmetrical axis of the second microlens array and the symmetrical axis of the miniature graphic array;

N₂ is a coefficient, N₂=0.1˜10;

T₂=20˜1000 μm, T₃ is same as defined in formula (3);

α₂=0−5°;

the term “macroscopic magnification of the second visual effect” refers to a ratio of the size of the macroscopic miniature graphics seen from the side of the miniature graphic layer by eyes to the actual size of the miniature graphics.

Referring to FIG. 5, it is the schematic diagram of the first microlens layer 1, the second microlens layer 2 and the miniature graphic layer 3 in a random arrangement, wherein the respective units are randomly distributed and there is no symmetrical axis in the plane. The superposition of two layers of random dot arrays with the same distribution but very small differences in size and angle will generate another Moire fringe, i.e. “Glass Pattern” phenomenon. The Moire fringe generated by the dot arrays in a periodic arrangement is also in the periodic arrangement and may always extend over the entire plane. However, the Glass Pattern phenomenon will only generate a single Moire fringe at a central point of the entire plane. When the microlens layer of a randomly distribution is superimposed with the miniature graphic layer of a randomly distribution, the same stereoscopic sloshing effect as the periodic arrangement can also be produced by the Glass Pattern principle and the lens imaging effect. The difference is that the periodic arrangement produces the stereoscopic sloshing effect of periodic macroscopic graphics and the random distribution arrangement produces the stereoscopic sloshing effect of a single macroscopic graphic.

The periodic distribution arrays and the random distribution arrays both follow the basic principle of Moire fringes. Therefore, the relevant theoretical formulae, formula (1) and formula (2), for the Moire amplification in a periodic distribution, as mentioned above are likewise applicable to the random distribution. By reasonably selecting the size ratio and the rotational angle of two layers of random distribution arrays, a naked-eye-stereoscopic and orthogonally sloshing visual effect will be also produced.

The preparation method of the present invention comprises the steps of:

(1) Determining the structural parameters D₁ and h₁ of the first microlens, and the structural parameters D₂ and h₂ of the second microlens to calculate the distance d₁ between the first microlens layer 1 and the miniature graphic layer 3 and the distance d₂ between the second microlens layer 2 and the miniature graphic layer 3.

(2) Preparing the second microlens layer 2 on the substrate film of the second microlens layer, the substrate film having a thickness of d₂, by a UV molding process, and then performing vacuum coating on the surface of the second microlens layer using the functional layer material to obtain the second microlens layer coated with said functional layer, wherein the coating has a thickness of 10˜1000 nm.

Preferably, the functional layer materials having different refractive indexes are adopted for coating for many times, preferably for 1-3 times.

(3) Coating the substrate layer of the first microlens layer on the other side of the functional layer so that the overall thickness of the film is d₁, the overall thickness of the film refers to the total thickness of the second microlens substrate, the second microlens layer, the functional layer and the substrate of the first microlens layer, wherein the substrate of the first microlens layer is selected from hot-compressible materials such as polyvinyl acetate, cellulose triacetate, polymethyl methacrylate, polystyrene, a mixture of alkyd resin and toluene diisocyanate, polyurethane, polypropylene, polyethylene-1,4-cyclohexane dimethylene terephthalate, and may be also selected from UV-curable materials such as epoxy acrylates, fatty acid-modified epoxy acrylates, and a mixture of styrene and epoxy acrylates; and then preparing the first microlens layer 1 on the first microlens substrate, preferably by a UV molding process, wherein the UV molding process is a conventional method, see the method reported in the following reference: C. Y. Chang, S. Y. Yang, M. H. Chu, “Rapid fabrication of ultraviolet-cured polymer microlens arrays by soft roller stamping process” [J]. Micromech. Microeng. 84(2007)355-361.

(4) Preparing the miniature graphic layer 3 on the other side of the substrate of the second microlens layer, preferably by the method of printing a miniature graphic as disclosed in the applicant's Chinese Patent No. 201110074244.0, so as to obtain the micro-optical device for double-sided imaging.

The micro-optical device for double-sided imaging of the present invention may be used for preparing the security line of bills.

FIG. 9 is a schematic diagram of a bill having double-sided window security lines that utilizes the micro-optical device of the present invention. The micro-optical device of the present invention is partially exposed on both A and B sides of the bill. FIG. 10 is a sectional schematic diagram of a bill.

The first visual effect of the micro-optical device of the present invention can be seen by observing the security line from the A-side window 131, and the second visual effect of the micro-optical device of the present invention can be seen by observing the security line from the B-side window 132, which greatly enhances the anti-counterfeiting characteristic of the security line.

### Example 1

Preparing the micro-optical device for double-sided imaging having the structures shown in FIG. 1 and FIG. 4.

The pore size D₁ of the first microlens 11 is 30 microns, the spherical cap height h₁ is 6 μm; the pore size D₂ of the second microlens 21 is 60 μm, the spherical cap height h₂ is 10 μm; α₁=0.3°, α₂=0;

The geometry of the base of the first microlens 11 and the second microlens 21 is a regular hexagon;

The first microlens 11, the second microlens 21 and the miniature graphic are in a periodic arrangement;

Both the first microlens 11 and the second microlens 21 are spherical lenses.

The filling rate of the first microlens 1 is 80%;

The filling rate of the second microlens layer 2 is 79%;

The functional layer is a 65 nm thick zinc sulfide coating with a refractive index of 2.35;

The miniature graphic layer 3 is located near the transmission focal plane of the first microlens layer 1, the distance d₁ between the first microlens layer 1 and the miniature graphic layer 3 and the structural parameters of the first microlens 11 satisfy the following relationship:

$${d}_{1} = \frac{{D}_{1}^{2} + 4 {h}_{1}^{2}}{8 {h}_{1} ( {n}_{1} - 1 )} \qquad ( 1 )$$

wherein:

the parameters of the first microlens are substituted into the above formula to obtain the distance d₁ between the first microlens layer 1 and the miniature graphic layer, d₁ 43.5 μm.

The miniature graphic layer 3 is also located near the reflection focal plane of the second microlens 21. The distance d2 between the second microlens 2 and the miniature graphic layer 3 and the structural parameters of the second microlens 21 satisfy the following relationship:

$${d}_{2} = \frac{{D}_{2}^{2} - 12 {h}_{2}^{2}}{16 {h}_{2}} \qquad ( 2 )$$

wherein:

the parameters of the second microlens are substituted into the formula to obtain the distance d₂ between the second microlens layer and the miniature graphic layer, d₂=15 μm.

The parameters of the first microlens layer 1 and the miniature graphic layer 3 satisfy the following relationship:

$${m}_{1} = \frac{{N}_{1} {T}_{1}}{\sqrt{{( {T}_{3} cos {α}_{1} - {N}_{1} {T}_{1} )}^{2} + {( {T}_{3} sin {α}_{1} )}^{2}}} \qquad ( 3 )$$

wherein:

T₁ is the arrangement period of the first microlens array layer, which is 32 μm;

T₃ is the arrangement period of the miniature graphic array, which is 32 μm;

α₁ is the inclined angle between the symmetrical axis of the first microlens array and the symmetrical axis of the miniature graphic array, which is 0.3°;

N₁=1.

The parameters of the second microlens layer 2 and the miniature graphic layer 3 satisfy the following relationship:

$${m}_{2} = \frac{{N}_{2} {T}_{2}}{\sqrt{{( {T}_{3} cos {α}_{2} - {N}_{2} {T}_{2} )}^{2} + {( {T}_{3} sin {α}_{2} )}^{2}}} \qquad ( 4 )$$

wherein:

T₂ is the arrangement period of the second microlens array, which is 64.32 μm;

T₃ is the arrangement period of the miniature graphic array, which is 32 μm;

α₂ is the inclined angle between the symmetrical axis of the second microlens array and the symmetrical axis of the miniature graphic array, which is 0°;

N₂ is a coefficient, N₂=2;

The results are calculated as follows: m₁=190, m₂=100.

The preparation method comprises:

(1) Calculating according to the structural parameters of the first microlens and the second microlens to obtain that d₁=43.5 μm, d₂=15 μm.

(2) Preparing the second microlens layer having a pore size of 60 μm and a spherical cap height of 10 μm by a UV molding process on a 15 μm thick PET substrate, and coating a zinc sulfide coating with a thickness of 65 nm on the surface of the second microlens layer.

(3) Coating polyethylene resin on the surface of the zinc sulfide coating so that the overall thickness of the film layer reaches 43.5 μm; and then preparing the first microlens layer having a pore size of 30 μm and a spherical cap height of 6 μm on the polyethylene resin by the UV molding process.

(4) Finally preparing the miniature graphic layer on the other side of the PET substrate, by adopting the method of printing a miniature graphic as disclosed in the applicant's Chinese Patent No. 201110074244.0.

It can be seen from formulae (3) and (4) that the ratio of period of the microlens array to the miniature graphic array and the inclined angle α have the most direct impact on the visual effect. When α=0, namely, the symmetrical axes of the microlens array layer and the miniature graphic array layer are parallel to each other, the system will generate a naked-eye-stereoscopic visual effect. If the ratio of period of the microlens array to the miniature graphic array is greater than 1, the visual effect is reflected as stereoscopic subsidence; and if the ratio of period of the microlens array to the miniature graphic array is less than 1, the visual effect is reflected as stereoscopic floating. When the ratio of period of the microlens to the miniature graphic is equal to 1, and α≠0, the system will generate an orthogonally sloshing visual effect.

In the device of the present invention, there are three layer relationship combinations: the first microlens layer and the miniature graphic layer, the second microlens layer and the miniature graphic layer, and the first microlens layer and the second microlens layer.

In the case where the miniature graphic parameters are fixed, multiple visual effect combinations can be realized by designing different first microlens parameters and second microlens parameters.

In this Example, D1=30 μm, D2=60 μm, T1/T3=1, α₁=0.3°, T2/T3=0.995, α₂=0, the final effect is that the first visual effect is orthogonally sloshing, the second visual effect is stereoscopic subsidence, and a layer of faint Moire fringe will be seen from both the first visual effect and the second visual effect.

### Example 2

Preparing the micro-optical device for double-sided imaging having the structures as shown in FIG. 1 and FIG. 6.

The pore size D₁ of the first microlens 11 is 40 μm, the spherical cap height h₁ is 8 μm; the pore size D₂ of the second microlens 21 is 80 μm, the spherical cap height h₂ is 12.3 μm; α₁=0.4°, α₂=0;

The geometry of the base of the first microlens 11 and the second microlens 21 is a circle;

The first microlens 11, the second microlens 21 and the miniature graphic are in a random arrangement;

Both the first microlens 11 and the second microlens 21 are spherical lenses.

The filling rate of the first microlens layer 1 is 68%;

The filling rate of the second microlens layer 2 is 68%;

The functional layers are a 30 nm thick zinc sulfide coating and a 40 nm thick Yttrium coating, having a refractive index of 2.35 and 1.8, respectively.

The miniature graphic layer 3 is located near the transmission focal plane of the first microlens layer 1, the distance d₁ between the first microlens layer 1 and the miniature graphic layer 3 and the structural parameters of the first microlens 11 satisfy the following relationship:

$${d}_{1} = \frac{{D}_{1}^{2} + 4 {h}_{1}^{2}}{8 {h}_{1} ( {n}_{1} - 1 )} \qquad ( 1 )$$

wherein:

the parameters of the first microlens are substituted into the above formula to obtain the distance d₁ between the first microlens layer 1 and the miniature graphic layer, d₁=58 μm.

The miniature graphic layer 3 is also located near the reflection focal plane of the second microlens 21. The distance d₂ between the second microlens 2 and the miniature graphic layer 3 and the structural parameters of the second microlens 21 satisfy the following relationship:

$${d}_{2} = \frac{{D}_{2}^{2} - 12 {h}_{2}^{2}}{16 {h}_{2}} \qquad ( 2 )$$

wherein:

the parameters of the second microlens are substituted into the formula to obtain the distance d₂ between the second microlens layer and the miniature graphic layer, d₂=23 μm.

The parameters of the first microlens layer 1 and the miniature graphic layer 3 satisfy the following relationship:

$${m}_{2} = \frac{{N}_{1} {T}_{2}}{\sqrt{{( {T}_{3} cos {α}_{2} - {N}_{1} {T}_{2} )}^{2} + {( {T}_{3} sin {α}_{2} )}^{2}}} \qquad ( 3 )$$

wherein:

T₁ is the arrangement period of the first microlens array layer, which is 43 μm;

T₃ is the arrangement period of the miniature graphic array, which is 43 μm;

α₁ is the inclined angle between the symmetrical axis of the first microlens array and the symmetrical axis of the miniature graphic array, which is 0.4°;

N₁=1.

The parameters of the second microlens layer 2 and the miniature graphic layer 3 satisfy the following relationship:

$${m}_{2} = \frac{{N}_{2} {T}_{2}}{\sqrt{{( {T}_{3} cos {α}_{2} - {N}_{2} {T}_{2} )}^{2} + {( {T}_{3} sin {α}_{2} )}^{2}}} \qquad ( 4 )$$

wherein:

T₂ is the arrangement period of the second microlens array, which is 85.14 μm;

T₃ is the arrangement period of the miniature graphic array, which is 43 μm;

α₂ is the inclined angle between the symmetrical axis of the second microlens array and the symmetrical axis of the miniature graphic array, which is 0°;

N₂ is a coefficient, N₂=2;

The results are calculated as follows: m₁=143, m₂=100;

The preparation method comprises:

(1) Calculating according to the structural parameters of the first microlens and the second microlens to obtain that d₁=58 μm, d₂=23 μm.

(2) Preparing the second microlens layer having a pore size of 80 μm and a spherical cap height of 12 μm by a UV molding process on a 23 μm thick PET substrate, and coating a zinc sulfide coating with a thickness of 30 nm and a Yttrium coating with a thickness of 40 nm on the surface of the second microlens layer.

(3) Coating polyethylene resin on the surface of the Yttrium coating so that the overall thickness of the film layer reaches 58 μm; and then preparing the first microlens layer having a pore size of 40 μm and a spherical cap height of 8 μm on the polyethylene resin by the UV molding process.

(4) Finally preparing the miniature graphic layer on the other side of the PET substrate, by adopting the method of printing a miniature graphic as disclosed in the applicant's Chinese Patent No. 201110074244.0.

### Example 3

Preparing the micro-optical device for double-sided imaging as shown in FIG. 11.

The second microlens 21 has a pore size of D₂=51.5 μm, an arrangement period of T₂=63.36 μm and a filling rate of 60%, the functional layer 4 has the material of hafnium oxide, a thickness of 50 nm and a refractive index of 2.0, and the other structural parameters are the same as those in Example 1. Under the above structural parameters, the information about the second visual effect cannot be directly identified and will be identified by irradiation with an additional point light source or parallel light source.

### Example 4

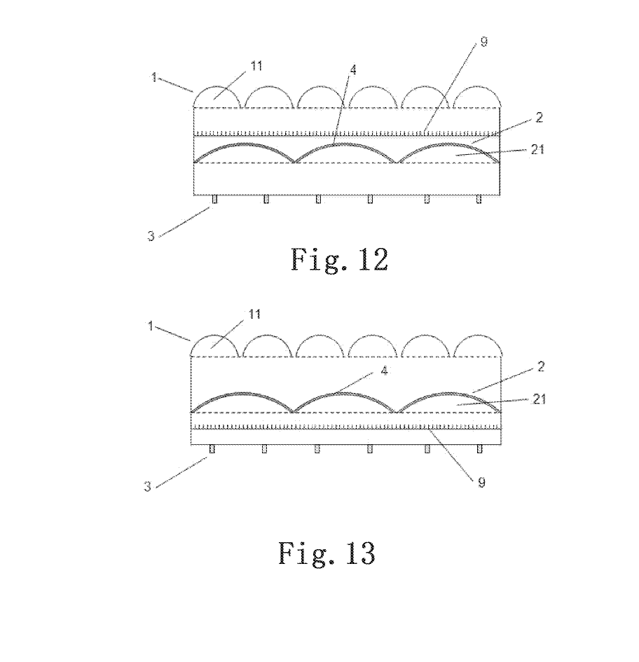

As shown in FIG. 12, this Example is a variant of Example 1, and its structure is the same as that defined in Example 1, except that a holographic information layer 9 is added between the first microlens layer and the second microlens layer. At present, the holographic technology has been very mature, and lithography holographic can produce various colorful holographic effects. Essentially, the production of the holographic effect is the interference fringe generated by incident lights of different wavelengths on the grating structures of different orientations and different parameters. The microlens array consists of many micron-scale spherical lenses, and each of the small lenses converges the light to form a highly divergent light cone. When the microlens array is directly combined with the holography, the characteristics of converging the light of the microlens will damage the propagation route of the interference fringes and make the holographic effect disappear. In the present invention, the presence of micro-arc faced functional layer is just to generate a layer of micro-arc shaped refractive index difference within the material, and the layer of refractive index difference has a very small influence on the propagation of light. The interference light generated by the holographic information layer can be observed by the human eyes through the micro-arc faced functional layer. Therefore, only the first visual effect can be seen when one observes from the side of the first microlens, and the holographic information cannot be seen, in this Example. When one observes from the side of the miniature graphic layer, both the second visual effect and the holographic information can be seen. At present, due to the popularity and popularization of the holographic technology, the simple holographic anti-counterfeiting function is more and more weak. In this Example, the holographic technology and the micro-optical technology are combined efficiently, which not only greatly improves the ornamental performance of products, but also increases the technical difficulty thereof.

The preparation method comprises:

(1) Calculating according to the structural parameters of the first microlens and the second microlens to obtain that d₁=43.5 μm, d₂=15 μm.

(2) Preparing the second microlens layer having a pore size of 60 μm and a spherical cap height of 10 μm by a UV molding process on a 15 μm thick PET substrate, and coating a zinc sulfide coating with a thickness of 65 nm on the surface of the second microlens layer.

(3) Coating polyethylene resin on the surface of the zinc sulfide coating so that the overall thickness of the film layer reaches 30 μm; then preparing a specific holographic information layer on the polyethylene resin by a thermo-molding process, conducting the surface treatment and then re-coating the polyethylene resin so that the overall thickness of the film layer reaches 43.5 μm; and preparing the first microlens layer having a pore size of 30 μm and a spherical cap height of 6 μm by the UV molding process.

(4) Finally preparing the miniature graphic layer on the other side of the PET substrate, by adopting the method of printing a miniature graphic as disclosed in the applicant's Chinese Patent No. 201110074244.0.

FIG. 13 is another variant of the structure.

A holographic information layer is positioned between the second microlens layer 2 and the miniature graphic layer 3, and the same effect as FIG. 12 can be obtained.

1. A micro-optical device for double-sided imaging, characterized in that it comprises a first microlens layer (1), a functional layer (4), a second microlens layer (2) and a miniature graphic layer (3) which are mutually compounded in sequence;
the first microlens layer (1) is a first microlens array formed by arranging a plurality of first microlenses (11);
the second microlens layer (2) is a second microlens array formed by arranging a plurality of second microlenses (21);
the functional layer is arranged on the surface of the second microlens layer (2), and a material for the functional layer has a refractive index greater than that of a surrounding material.

2. The micro-optical device for double-sided imaging according to claim 1, characterized in that the first microlens layer (1) is a first microlens array formed by arranging the first microlens (11) in a periodic arrangement or a random arrangement, and the second microlens layer (2) is a second microlens array formed by arranging the plurality of second microlens (21) in a periodic arrangement or a random arrangement.

3. The micro-optical device for double-sided imaging according to claim 1, characterized in that a refractive index of the substrate of the first microlens layer (1) is 1.4 to 1.8, and a refractive index of the substrate of the second microlens layer (2) is 1.4 to 1.8.

4. The micro-optical device for double-sided imaging according to claim 2, characterized in that a refractive index of the substrate of the first microlens layer (1) is 1.4 to 1.8, and a refractive index of the substrate of the second microlens layer (2) is 1.4 to 1.8.

5. The micro-optical device for double-sided imaging according to claim 1, characterized in that the first microlens 11 or the second microlens 21 is a spherical lens or an aspherical lens.

6. The micro-optical device for double-sided imaging according to claim 5, characterized in that the geometry of the base of the first microlens or the second microlens is one of circle, triangular, rectangular or regular hexagon, or a combination thereof.

7. The micro-optical device for double-sided imaging according to claim 6, characterized in that a ratio of the total area of the first microlens to the total area of the first microlens layer is in a range of from 40% to 90%, and a ratio of the total area of the second microlens to the total area of the second microlens layer is in a range of from 40% to 90%.

8. The micro-optical device for double-sided imaging according to claim 1, characterized in that the layer number of the functional layer is 1 or more.

9. The micro-optical device for double-sided imaging according to claim 8, characterized in that the layer number of the functional layer is two, the first functional film layer (41) is compounded on the surface of the second microlens layer, the second functional film layer is compounded on the surface of the first functional film layer; the refractive index of the first functional film layer (41) is greater than that of the second functional film layer (42), the refractive index of the second functional film layer (42) is greater than that of the surrounding material, and the difference between the refractive index of the first functional film layer (41) and the refractive index of the second functional film layer is 0.3 to 0.8.

10. The micro-optical device for double-sided imaging according to claim 9, characterized in that the refractive index of the material for the functional layer is 1.6 to 3.5 and the difference between the refractive index of the material for the functional layer and the refractive index of the surrounding material is 0.3 to 2.0.

11. The micro-optical device for double-sided imaging according to claim 8, characterized in that the material for the functional layer is selected from the group consisting of an oxide, a nitride, a carbide, an inorganic metal salt, a metal or a metal alloy;
the oxide is selected from the group consisting of silicon monoxide SiO, silica SiO₂, titania TiO₂, zirconium dioxide ZrO₂, hafnium oxide HfO₂, titanium monoxide TiO, trititanium pentoxide Ti₃O₅, niobium pentoxide Nb₂O₅, tantalum pentoxide Ta₂O₅, yttrium oxide Y₂O₃ or zinc oxide ZnO;
the nitride is selected from the group consisting of titanium nitride TiN, silicon nitride Si₃N₄ or boron nitride BN;
the carbide is selected from the group consisting of silicon carbide SiC or boron carbide B₄C;
the inorganic metal salt is selected from the group consisting of neodymium fluoride NdF₃, barium fluoride BaF₂, cerium fluoride CeF₃, magnesium fluoride MgF₂, lanthanum fluoride LaF₃, yttrium fluoride YF₃, ytterbium fluoride YbF₃, erbium fluoride ErF₃, zinc selenide ZnSe, zinc sulfide ZnS, lanthanum titanate LaTiO₃, barium titanate BaTiO₃, strontium titanate SrTiO₃, praseodymium titanate PrTiO₃ or cadmium sulfide CdS;
the metal is selected from the group consisting of Al, Cu, Ti, Si, Au, Ag, In, Mg, Zn, Pt, Ge and Ni;
the metal alloy is selected from the group consisting of gold germanium alloy AuGe, gold nickel alloy AuNi, nickel chromium alloy NiCr, titanium aluminum alloy TiAl, copper indium gallium alloy CuInGa, copper indium gallium selenium alloy CuInGaSe, zinc aluminum alloy ZnAl or aluminum silicon alloy AlSi.

12. The micro-optical device for double-sided imaging according to claim 1, characterized in that the miniature graphic layer is a miniature graphic array arranged in a periodic arrangement or in a random arrangement.

13. The micro-optical device for double-sided imaging according to claim 12, characterized in that the miniature graphic layer is located near the transmission focal plane of the first microlens layer and also near the reflection focal plane of the second microlens layer.

14. The micro-optical device for double-sided imaging according to claim 13, characterized in that a distance d₁ between the first microlens layer (1) and the miniature graphic layer (3) and the structural parameters of the first microlens (11) satisfy the following relationship:
$${d}_{1} = \frac{{D}_{1}^{2} + 4 {h}_{1}^{2}}{8 {h}_{1} ( {n}_{1} - 1 )} \qquad ( 1 )$$
wherein:
D₁ is the pore size of the first microlens 11;
h₁ is the spherical cap height of the first microlens 11;
n₁ is the refractive index of the material for the first microlens;
a distance d₂ between the second microlens layer and the miniature graphic layer 3 and the structural parameters of the second microlens satisfy the following relationship:
$${d}_{2} = \frac{{D}_{2}^{2} - 12 {h}_{2}^{2}}{16 {h}_{2}} \qquad ( 2 )$$
wherein:
D₂ is the pore size of the second microlens 21;
h₂ is the spherical cap height of the second microlens 21.

15. The micro-optical device for double-sided imaging according to claim 1, characterized in that when the first microlens array, the second microlens array and the miniature graphic array are in the periodic arrangement, the parameters satisfy the following relationship:
$${m}_{1} = \frac{{N}_{1} {T}_{1}}{\sqrt{{( {T}_{3} cos {α}_{1} - {N}_{1} {T}_{1} )}^{2} + {( {T}_{3} sin {α}_{1} )}^{2}}} \qquad ( 3 )$$
wherein:
m₁ is a macroscopic magnification of the first visual effect, T₁ is the arrangement period of the first microlens array layer, T₃ is the arrangement period of the miniature graphic array, α₁ is an inclined angle between the symmetrical axis of the first microlens array and the symmetrical axis of the miniature graphic array; as shown in FIGS. 5, A1 and B1 are symmetrical axes of the first microlens array, A3 and B3 are symmetrical axes of the miniature graphic array in FIG. 5;
N₁ is a ratio coefficient, N₁=0.1˜10;
T₁=20˜500 μm, T₃=20˜500 μm, α₁=0˜5°;
the parameters of the second microlens layer and the miniature graphic layer satisfy the following relationship:
$${m}_{2} = \frac{{N}_{2} {T}_{2}}{\sqrt{{( {T}_{3} cos {α}_{2} - {N}_{2} {T}_{2} )}^{2} + {( {T}_{3} sin {α}_{2} )}^{2}}} \qquad ( 4 )$$
wherein:
m₂ is a macroscopic magnification of the second visual effect, T₂ is the arrangement period of the second microlens array, T₃ is the arrangement period of the miniature graphic array, α₂ is an inclined angle between the symmetrical axis of the second microlens array and the symmetrical axis of the miniature graphic array;
N₂ is a ratio coefficient, N₂=0.1˜10;
T₂=20˜1000 μm, T₃ is same as defined in formula (3);
α₂=0˜5°.

16. The micro-optical device for double-sided imaging according to claim 1, characterized in that a holographic information layer (9) is provided between the first microlens layer and the second microlens layer, or provided between the second microlens layer and the miniature graphic layer.

17. The micro-optical device for double-sided imaging according to claim 8, characterized in that a holographic information layer (9) is provided between the first microlens layer and the second microlens layer, or provided between the second microlens layer and the miniature graphic layer.

18. A method of preparing the micro-optical device for double-sided imaging according to claim 1, characterized in that it comprises the steps of:
(1) determining the structural parameters D₁ and h₁ of the first microlens, and the structural parameters D₂ and h₂ of the second microlens to calculate the distance d₁ between the first microlens layer 1 and the miniature graphic layer and the distance d₂ between the second microlens layer and the miniature graphic layer;
(2) preparing the second microlens layer on the substrate film of the second microlens layer, the substrate film having a thickness of d₂, and then performing vacuum coating on the surface of the second microlens layer using the functional layer material to obtain the second microlens layer coated with said functional layer;
(3) coating the substrate layer of the first microlens layer on the other side of the functional layer; and
(4) preparing the miniature graphic layer on the other side of the substrate of the second microlens layer to obtain the micro-optical device for double-sided imaging.

19. The micro-optical device for double-sided imaging according to claim 1, characterized in that the device is used for preparing the security line of bills.
